(19) United States
(12) Patent Application Publication
(10) Pub. No.: US 2005/0188367 A1
(43) Pub. Date: Aug. 25, 2005

(54) Executable application configuration system

(76) Inventor: Brian K. Oberholtzer, Glenmoore, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/067,153

(22) Filed: Feb. 24, 2005

Related U.S. Application Data
(60) Provisional application No. 60/547,690, filed on Feb. 25, 2004.
(60) Provisional application No. 60/555,218, filed on Mar. 22, 2004.

(51) Int. Cl. G06F 9/44; G06F 9/445

(52) U.S. Cl. 717/168

(57) ABSTRACT

A system, for configuring an executable application, includes a repository and an executable procedure. The repository includes adaptation data for configuring executable applications. The repository includes information for determining user authorization to access a particular executable application, and information for determining user association with a predetermined entity. The executable procedure is associated with the adaptation data stored in the repository, and updates configuration information of the particular executable application with the adaptation data retrieved from the repository.

### CROSS-REFERENCE TO RELATED APPLICATIONS

The present application is a non-provisional application of provisional applications, having Ser. No. 60/547,690 filed Feb. 25, 2004 and Ser. No. 60/555,218, filed Mar. 22, 2005 by Brian K. Oberholtzer.

### FIELD OF THE INVENTION

The present invention generally relates to computer information systems. More particularly, the present invention relates to a computer information system including an executable application configuration system for configuring an executable application in a customer system.

### BACKGROUND OF THE INVENTION

Software applications, especially enterprise-wide software applications, often require a substantial configuration task to be completed during deployment and again later for maintenance. Examples of configuration requirements for a software application include creating user accounts and security groups, and defining of departments within an organization. The effort required to configure the software applications, especially the security related portions of applications, is time consuming and expensive.

Many times, software applications are composed from a number of different technologies, and developed by a distributed set of development organizations and vendors. Disparate configuration information needed to deploy a software application, comprised of disparate software components, can be confusing, complicated, expensive, and time consuming.

Customers using the software applications may be a convenient party to perform the configuration process. However, customers are not the preferred party to enter their own configuration information because of the complexity of the configuration and the vulnerability of the resources during the configuration.

Further, the configuration process is complex for customers because of the number and complexity of the tools needed. Customer resources need to be devoted to do the configuration. When a customer wants to deploy new configuration options, configuration information needs to be continually modified to keep it current. Due to these customer issues, customers typically hire someone else to perform the configuration. However, acquiring configuration changes from a customer is laborious and error prone. Further, a customer may have little incentive to get the configuration right early or may make do with an existing configuration without making the proper changes.

Resources are vulnerable when a customer performs the configuration process because some configuration utilities are directly coupled to the deployed software application. When changes are made though a configuration user interface, configuration information is changed in the software application. When customers are not familiar enough with the new software application being installed, there is a significant risk that the software application may be compromised. This is especially critical when an application service provider deploys the software application where other customers may be sharing computer resources.

Some computer systems use automated systems, such as software development environments or meta directories, to assist in the configuration process. However, the automated systems do not manage disparate configuration information or do not manage all of the configuration information.

Software development environments, such as J2EE and Microsoft .NET, use XML files to hold the configuration information. For example, in J2EE, the XML file is called a deployment descriptor. However, the XML files are typically used in a single development environment and cannot manage configuration information stored in disparate customer systems. Further, the XML configuration files associated with J2EE do not permit configuration of all information in the software application. For example, security roles can be configured within the deployment descriptor but not user accounts and group memberships. User accounts and group memberships are often configured in a directory as a separate process.

Meta directories, such as DirX, are used to synchronize configuration information, such as user passwords, between disparate data memories of multiple customer systems. Meta directories update configuration information to one memory from another memory by reading the configuration information from one memory into a meta-model, and then using the same model to write the configuration information to a different memory. For example, when the user changes a password on one customer system, the meta directory detects that activity and signals the memories on the other customer systems to update the user's password to match. Meta directories permit customer systems that store passwords in multiple locations to keep them synchronized. However, meta directories focus on real-time synchronization of data between memories; whereas, management of configuration information for setup purposes does not necessarily operate during runtime. Further, meta directories do not permit configuration of all software application information.

Accordingly, there is a need for an executable application configuration system for configuring an executable application in a customer system that overcomes these and other disadvantages of the prior systems.

### SUMMARY OF THE INVENTION

A system, for configuring an executable application, includes a repository and an executable procedure. The repository includes adaptation data for configuring executable applications. The repository includes information for determining user authorization to access a particular executable application, and information for determining user association with a predetermined entity. The executable procedure is associated with the adaptation data stored in the repository, and updates configuration information of the particular executable application with the adaptation data retrieved from the repository.

### BRIEF DESCRIPTION OF THE DRAWINGS

FIG. 1 illustrates a computer information system including an executable application configuration system and a customer system.

FIG. 2 illustrates architecture of the computer information system, as shown in FIG. 1.

FIG. 3 illustrates a method for configuring executable applications.

### DETAILED DESCRIPTION OF THE PREFERRED EMBODIMENTS

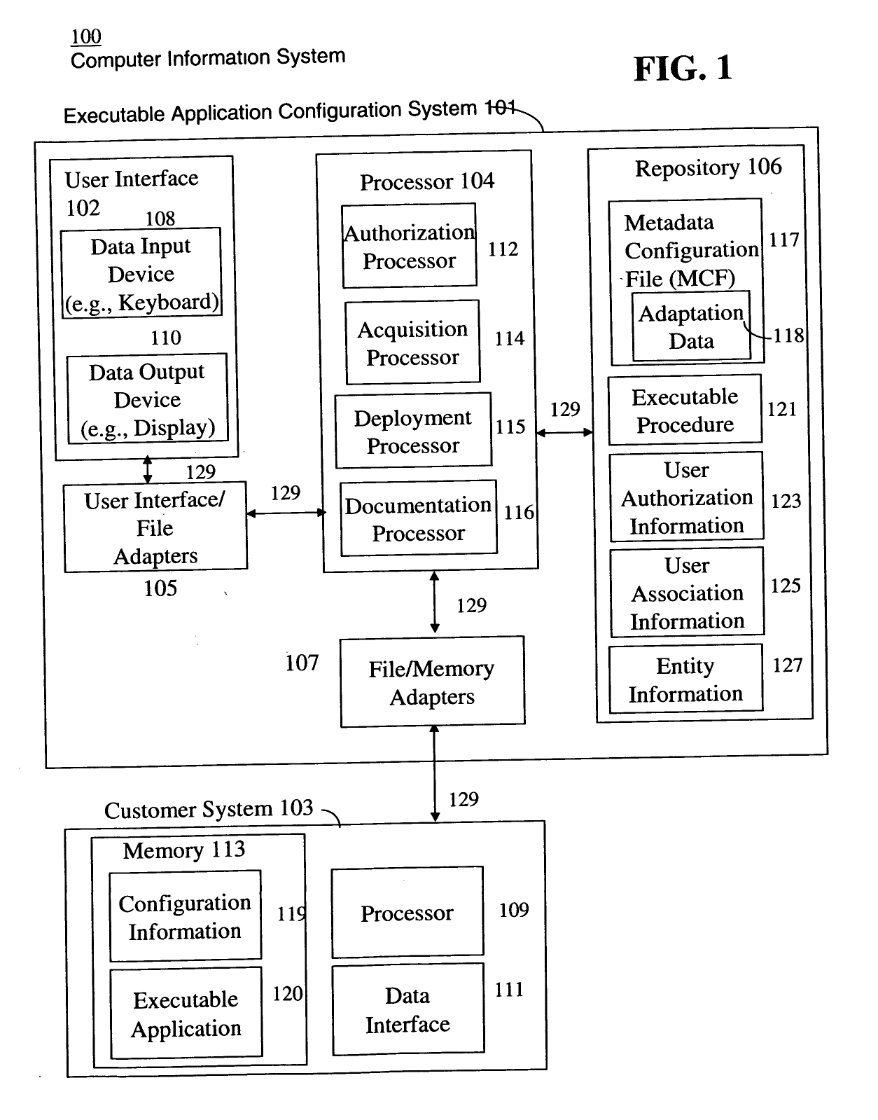

FIG. 1 illustrates a computer information system 100 including an executable application configuration system (“configuration system”) 101 and a customer system 103. The configuration system 101 communicates with the customer system 103 to update configuration information 119 stored in the memory 113 of the customer system 103.

The configuration system 101 includes a user interface 102, a processor 104, a repository 106, one or more user interface/file adapters 105, and one or more file/memory adapters 107 communicating with each other, as shown, over communication path 129. The user interface 102 includes a data input device 108 and a data output device 110. The processor 104 includes an authorization processor 112, an acquisition processor 114, a deployment processor 115, and a documentation processor 116. The repository 106 includes a metadata configuration file 117 including adaptation data 118, an executable procedure 121, user authorization information 123, user association information 125, and entity information 127.

The customer system 103 includes a processor 109, a data interface 111, and a memory 113. The memory 113 further includes one or more sets of configuration information 119 associated with one or more executable applications 120.

The customer system 103 may be employed by any type of enterprise, organization, or department, such as, for example, providers of healthcare products and/or services responsible for servicing the health and/or welfare of people in its care. For example, the customer system 103 represents a hospital information system. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

Each of the configuration system 101 and the customer system 103 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. Elements of each of the configuration system 101 and the customer system 103 also may be implemented in a centralized or decentralized configuration.

The elements in the system 100 are interconnected, as shown in FIG. 1, using one or more communication paths 129 (otherwise called network, bus, link, connection, channel, etc.). The elements in the computer information system 100 communicate over the communication paths 129 using any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits data to be received by or received from the processor 104. The data input device 108 provides data to the processor 104 in response to receiving input data either manually from a user or automatically from an electronic device, such as a computer. For manual input, the data input device 108 is a keyboard and a mouse, but also may be a touch screen, or a microphone with a voice recognition application, for example. For automatic input, the data input device 108 is a data modem.

The data output device 110 provides data from the processor 104 for use by a user or an electronic device, such as a computer. For output to a user, the data output device 110 is a display that generates display images in response to receiving the display signals from the processor 104, but also may be a speaker or a printer, for example. For electronic output to an electronic device, the data output device 110 is a data modem.

One or more elements of each of the configuration system 101 and the customer system 103 may be implemented in hardware, software, or a combination of both, and may include one or more processors, such as processor 104, for example. A processor is a device and/or set of machine-readable instructions for performing task. A processor includes any combination of hardware, firmware, and/or software. A processor acts upon stored and/or received information by computing, manipulating, analyzing, modifying, converting, or transmitting information for use by an executable application or procedure or an information device, and/or by routing the information to an output device. For example, a processor may use or include the capabilities of a controller or microprocessor.

Generally, an executable application comprises code or machine readable instruction for implementing predetermined functions including those of an operating system, a healthcare information system, or other information processing system, for example, in response user command or input. Examples of an executable application include the executable application 120 and the executable procedure 121.

The repository 106 (otherwise called a memory, or a centralized repository) represents one or more types of data storage devices, such as, for example, read only memory (ROM) and/or random access memory (RAM). The repository 106 stores adaptation data 118 for configuring the configuration information 119 for the executable application 120 using the executable procedure 121. The repository 106 associates particular adaptation data 118 with data representing a corresponding display image 110 used for acquiring the particular adaptation data 118 in response to user data entry via the data input device 108.

The repository 106 also stores information determining user authorization 123 to the entire system 100 or one or more particular parts of the system 100. For example, user authorization information 123 may determine access to a particular executable application 120.

The repository 106 also stores information determining a user association 125 with a predetermined entity 127. The predetermined entity includes at least one of the following: a particular group of users, an organization, a department within an organization, a location, and a constituent part of an organization.

The adaptation data 118 provides information to effect (e.g., change, update, renew, simulate, test, deploy, etc.) the configuration of the executable application 120. The configuration of the executable application 120 is represented by the configuration information 119.

The executable application procedure 121 is associated with a set or subset of the adaptation data 118 in the repository 106 for updating the configuration information 119 of an executable application 120 with a set or subset of adaptation data 118 retrieved from the repository 106.

The executable procedure 121 is adaptively selectable for updating configuration information 119 of a corresponding target executable application 120 using the adaptation data 118. The target executable application 120 is associated with a corresponding subset of adaptation data 118 in the repository 106.

The configuration information 119 includes at least one of the following: information associating a user 125 with a particular group of users, information indicating user authorization 123 to access an individual executable application 120 of a group of executable applications, information indicating user authorization 123 to access particular functions or features of an executable application 120, and information identifying specific configuration information 119 required by an executable application 120.

The acquisition processor 114 may acquire adaptation data 118 for configuring executable applications 120 from multiple different sources. The multiple different sources include at least one of the following: user data entry via a displayed image used for acquiring particular adaptation data 118, a file of adaptation data 118, network accessed sources, and a plurality of different memories.

The authorization processor 112 enables or inhibits particular users to be able to initiate execution of the executable procedure 121 for updating the configuration information 119 of the executable application 120 with the particular adaptation data 118 retrieved from the repository 106. The authorization processor 112 also enables or inhibits particular users to be able to initiate acquisition of the particular adaptation data 118 for storage in the repository 106 in response to user data entry into a corresponding display image of the data output device 110 used for acquiring the particular adaptation data 118.

The documentation processor 116 collates information recording an identity of a configured executable application 120 and associated configuration information 119 used in configuring the configured executable application 120. The collated information may be stored in the repository 106 for future reference and/or may be presented to the user via the data output device 110.

Generally, the configuration system 103 provides a system and inherent method to collect and manage adaptation data 118 via the user interface 102 on behalf of one or more executable applications 120 in the customer system 103. This may be accomplished, for example, though a software framework of plug-able software adapters 105 and 107 and published computer interfaces. Additionally, the collecting of the adaptation data 118 is separated in time and space from the deployment of that adaptation data 118 to an executable application 120 in the customer system 103. This is accomplished, for example, by storing the adaptation data 118 captured through the user interface 102 and associated user interface/file adapters 105 in a metadata configuration file 117 format. The metadata configuration file 117 is later used to apply the adaptation data 118 to an executable application 120 in the customer system 103.

The customer system 103 communicates with the configuration system 101 over the communication link 129 via the data interface 111 in the customer system 103. The data interface 111 includes a user interface, and has user interface and data interface capabilities, as described with the user interface 102 in the configuration system 101. The processor 109 communicates data received by the data interface 111 to the memory 113.

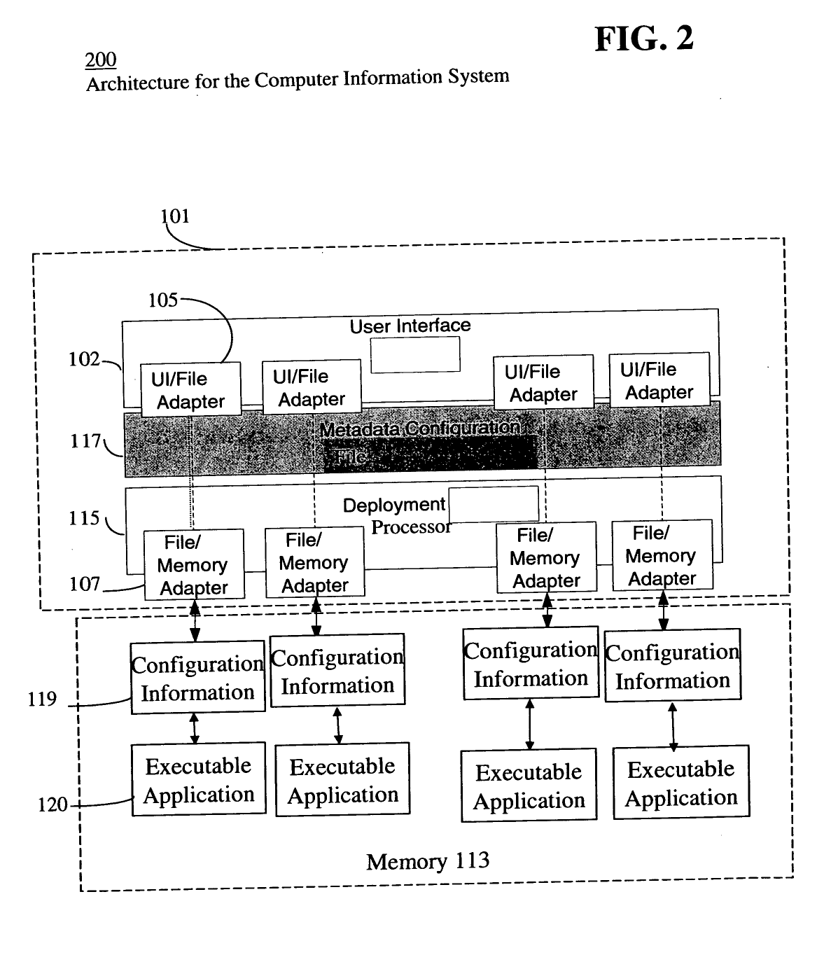

FIG. 2 illustrates architecture 200 of the computer information system 100, as shown in FIG. 1. The element shown in FIG. 2 are the same as the elements shown in FIG. 1, except that they are arranged in a different way further clarify the interaction of the configuration system 103 with the customer system 103. The architecture 200 of the system 100 includes the configuration system 101 and the memory 113 in the customer system 103. The configuration system 101 includes the user interface (“UI”) 102, the metadata configuration file (“MCF”) 117, the deployment processor 115, one or more UI/file adapters (“UIFA”) 105, and one or more file/memory adapters (“FMA”) 107. The memory 113 in the customer system 103 includes one or more sets of configuration information 119 and one or more executable applications 120. For example, FIG. 2 shows four of each of the elements 105, 107, 119, and 120, but there may be any number of these elements.

The system architecture 200 is platform independent because the system architecture 200 may be implemented on any number of hardware and/or software platforms. For example, the system architecture 200 may be implemented on Microsoft® Windows® operating system running on a personal computer, on Solaris® platform using X Window® operating system, under Java® operating system using Swing® platform, or using a browser using variety of web server technologies.

The user interface 102 uses a discovery mechanism to discover the existence of the user interface/file adapters 105. The system architecture 200 does not limit the type of discovery mechanism. Examples of discovery mechanisms include the following:
1. The user interface 102 identifies user interface/file adapters 105 by enumerating executable files within a file system directory. The files located in the file system directory are assumed to be the user interface/file adapters 105.
2. A registry registers individual user interface/file adapters 105. A registry may be a simple text file or something more sophisticated such as a Windows® system registry. The interrogated registry contains adequate information allowing the user interface 102 to identify the existing user interface/file adapters 105. The information in the registry includes the location and the file name containing the user interface/file adapters 105. Additional information may be included to further describe the user interface/file adapters 105. For example, individual user interface/file adapter may be associated with a unique identifier, which may be acquired by the user interface 102 though an interface method associated with the user interface/file adapter 102.

The user interface 102 provides some of the common user interface infrastructure with specific user interface infrastructure being provided by or described by the user interface/file adapters 105.

If the user interface 102 is implemented as a web application, browser frames may be used to display via the data output device 110 specific configuration screens for the user interface/file adapters 105. Alternatively, the adaptation data 118 for individual user interface/file adapters 105 may be displayed on a separate tab within a single user interface screen. In either case, the user interface/file adapters 105 may provide some amount of interaction with the user, if desired.

The metadata configuration file 117 is a file stored in the repository 106, on disk, or other computer readable media. The metadata configuration file 117 contains the adaptation data 118 provided through the user interface 102, as adapted by the user interface/file adapters 105.

The metadata configuration file 117 is independent and unaware of the configuration information 119 associated with the executable application 120 in the customer system 103. The metadata configuration file 117 uses the adaptation data 118 to configure the configuration information 119 associated with the executable application 120 in the customer system 103. Any type of file format and encoding mechanism used to implement the metadata configuration file 117, such as XML, for example.

The metadata configuration file 117 contains unique identifiers that are used to associate adaptation data 118, contained in the metadata configuration file 117, with the user interface/file adapters 105. The user interface/file adapters 105 understand and recognize the unique identifiers. The unique identifiers permit the contents of the metadata configuration file 117 to be displayed to the user through the user interface 102.

The deployment processor 115 controls the writing of the metadata configuration file 117 to the configuration information 119 associated with the executable application 120 in the customer system 103. The deployment processor 115 performs this process by parsing the adaptation data 118 in the metadata configuration file 117 to the appropriate file/memory adapter 107. The association between the adaptation data 118 and the appropriate file/memory adapter 107 is also made through the use of a unique identifier contained in the metadata configuration file 117 and/or the file/memory adapters 107. The unique identifier may be the same for different for each of the user interface/file adapters 105 and the file/memory adapters 107.

The deployment processor 115 may also control the creation of a metadata configuration file 117 by performing a capture of the configuration information 119, representing the adaptation data 118, from the customer system 103 via the file/memory adapters 107. For example, for an XML-type metadata configuration file 117, the file/memory adapters 107 receive and parse XML encoded data, representing the configuration information 119, from the customer system 103. The deployment processor 115 receives the parsed XML encoded data, representing the configuration information 119, from the file/memory adapters 107. The deployment processor 115 is configured to know which file/memory adapters 107 to call and in what order. The deployment processor 115 stores (i.e., writes) the XML encoded data, representing the configuration information 119, to the metadata configuration file 117 in the repository 106. Hence, the configuration information 119 from the customer system 103 becomes a portion of the adaptation data 118 stored in the repository 106.

The user interface/file adapters 105 may be implemented as software modules that contain user interface screens or other information needed to create user interface screens for the collection of the adaptation data 118. A user interface/file adapter 105 is created for the repository 106 storing the adaptation data 118. For example, if a table within a database is configured for deployment, a user interface/file adapter 105 is created to collect information for the columns of the table. A single user interface/file adapter 105 may present fields to configure more than one table. The scope of the adaptation data 118 collected by a single user interface/file adapter 105 is not dependent on the system architecture 200.

The user interface/file adapters 105 provide a consistent user interface for the user of the configuration system 101. The user interfaces may include application program interfaces (APIs) that allow the user interface 102 to integrate the user interface/file adapters 105 into the user interface presentation.

Services available through the user interface 102 include the ability to query the user interface/file adapters 105 for information about the user interface/file adapters 105. Additionally, the user interface 102 may determine how to present information to the user for the user interface/file adapters 105 or, conversely, to permit the user interface/file adapters 105 to determine how to provide information to the user via the user interface 102 for the collection of the adaptation data 118.

The user interface 102 is perceived by a user of the configuration system 101 and manages the user interface/file adapters 105. When a user selects a metadata configuration file 117 in the user interface 102, the metadata configuration file 117 is interrogated to find one or more unique identifiers associated with the metadata configuration file 117. The user interface 102 uses the unique identifier to identify and activate user interface/file adapters 105, which are used to edit the metadata configuration file 117. When the user closes the user interface 102, the user interface 102 automatically releases the activated user interface/file adapters 105.

The file/memory adapters 107 provide the connection between the metadata configuration file 117 and the configuration information 119 associated with the executable application 120 stored in the memory 113. The file/memory adapters 107 update the configuration information 119 associated with the executable application 120 using the adaptation data 118 from metadata configuration file 117 as directed by the deployment processor 115.

As with user interface/file adapters 105 being automatically discovered by the user interface 102, the deployment processor 115 may also automatically discover the file/memory adapters 107, using the discovery mechanisms described herein, for example.

The file/memory adapters 107 implement an interface allowing the deployment processor 115 to pass data to and receive data from the memory 113, without knowing the characteristics of the memory 113.

The file/memory adapters 107 may be associated with a unique identifier, which is understood by the file/memory adapters 107. A shared unique identifier may associate a file/memory adapter 107 with a user interface/file adapter 105. Hence, the user interface/file adapters 105 and/or the file/memory adapters 107 understand and recognize the unique identifier. Any number of adapter interfaces may be implemented. The configuration system 101 may reuse a unique identifier.

The file/memory adapters 107, in addition to being associated with a unique identifier, also contain a unique instance identifier. The unique instance identifier allows unique identification of a file/memory adapter 107. The unique instance identifier provides a mapping between the implementation supported by the file/memory adapter 107 and the configuration information 119 stored in the memory 113 that the file/memory adapter 107 knows how to read to and write from. In this case, the memory 113 in FIG. 2 would be separate for each configuration information 119 and associated executable application 120, representing different customer systems 103, for example.

Multiple file/memory adapters 107 are managed by the user interface 102, as perceived by a user of the configuration system 101. When an existing metadata configuration file 117 is selected in the user interface 102, the metadata configuration file 117 is interrogated to find the unique identifier associated with the metadata configuration file 117.

The file/memory adapters 107 may be loaded in two ways, for example.

1. The user may be prompted to select the list of available file/memory adapters 107 for corresponding implementations included in the metadata configuration file 117. This allows the user to configure the deployment processor 115 to be associated with particular file/memory adapters 107.

2. The configuration system 101 may implement file/memory adapter 107 sets, which represent a group of file/memory adapters 107 that are pre-configured to work with a particular metadata configuration file 117. The file/memory adapter 107 may be represented as or associated with a metadata configuration file 117, perhaps encoded as XML, for example.

More generally, adapter sets represents a group of adapters (e.g., user interface/file adapters 105 and/or file/memory adapters 107) that are installed using the user interface 102. For example, the configuration system 101 includes two adapter sets 105 and 107 with two unique identifiers: one for the user interface/file adapters 105 and one for the file/memory adapters 107. The user interface 102 determines if the needed adapters are present to support a given system architecture 200. Additionally, the user interface 102 supports the selecting of adapters to be used at a particular time. The configuration system 101 saves a selected set of adapters as a set identified by an identifier, such as a unique identifier and a name, for example. The metadata configuration file 117 may include a reference to an adapter set to reduce the chance for error in working with a metadata configuration file 117.

In operation, a user may perform one or more of the following tasks using the user interface 102.

1. The user may load an existing metadata configuration file 117.
a. If the metadata configuration file 117 includes a reference to an adapter set and the set is found, it is automatically loaded into the user interface 102.
b. If the metadata configuration file 117 includes an adapter set identifier, but the adapter set is not found, then an indication is provided to the user that configuration of an adapter set is needed.

2. The user may configure the adapter sets. The user interface 102 provides a list of available adapter sets, and permits the user to select desired adapter sets to be implemented. This task may be performed independently for each of the user interface/file adapters 105 and the file/memory adapters 107. The adapter sets that are applicable to a current metadata configuration file 117 (e.g., through matching unique identifiers) may be shown on the display 110 with a special graphical indication. The user interface 102 may prevent the selection of more than one like adapter set to prevent confusion.

3. The user may enter adaptation data 118 in fields provided through configured user interface/file adapters 105.

4. The user may save the entered adaptation data 118 to the metadata configuration file 117.

5. The user may apply the adaptation data 118 in the metadata configuration file 117 to the configuration information 119 stored in the memory 113 of the customer system 103 via the deployment processor 115 and the file/memory adapters 1074.

6. When the user interface 102 is used to configure security or other information, the user interface 102 may provide the ability to simulate a logon by a given user. When simulating logon by a given user, the user interface 102 shows user-sensitive security settings based on the user's identity. This may be used to evaluate a security configuration, as described by the follow two examples.
a. A user, an identity, or a security group, for example, may be entered into the user interface 102 to start a simulation of a user logging onto the configured executable application 120 to permit the simulated user to pretend to be an actual user on the customer system 103. An advantage of this feature is for a simulated user to experience a configured executable application 120 as an actual user in a live customer system 103.
b. As the configuration information 119 is viewed in the simulated mode, the user interface 102 gives feedback to the user to show properties of the customer system 103, as experienced by the simulated user before deploying the configuration information 119 to customer system 103. For example, if authorization information 123 is configured in the user interface 102, then, when the user identifies secured items in the display, a message may appear indicating if the user is granted or denied access to that feature of the executable application 120. Numerous types of information and means to communicate may be used to feedback information to the user using the user interface 102 to understand how a simulated user would experience a configured customer system 103. An advantage of this feature is to debug a configured customer system 103 while it is in a simulated mode, before it is actually applied to the customer system 103.

7. The user may create a metadata configuration file 117. The deployment processor and the file/memory adapters 107 control the application of the metadata configuration file 117 to the configuration data 119 stored in the memory 113 of the customer system 103.

8. The user may perform comparisons showing differences between two or more metadata configuration files 117. This enables the user, for example, to understand the changes that have occurred since a metadata configuration file 117 was last applied to the configuration data 119 stored in the memory 113 of the customer system 103.

The system 100 advantageously decouples a user's entering of adaptation data 118 from the setting of configuration information 119 in the memory 113 by using a metadata configuration file 117 that stores the adaptation data 118. The metadata configuration files 117 may be created and modified by a user and may be created by reverse engineering (i.e., pulling) data from actual configuration information 119 stored in the memory 113 of the customer system 103.

A custom deployment tool may be created to consolidate the collecting of adaptation data 118 and the writing of that information to a variety of configuration information 119 in a variety of memories 113. This may be done in the absence of a metadata configuration file 117 and/or the adapter based approach, for example.

The configuration system 101 provides a method and mechanism for simplifying configuration of executable applications 120 in the customer system 103, and may be further applied to the fields of executable application development and deployment. The configuration system 101 may be used for security and general-purpose configuration for executable applications 120.

The configuration system 101 provides the following benefits.

1. The configuration system 101 permits preparation of the configuration before deployment of the executable application 120. This speeds the deployment of the executable application 120, thereby permitting earlier revenue recognition.

2. The metadata configuration file 117 permits customers to develop their configuration, without affecting the actual deployment of their system 103. For example, for application service provider (ASP) deployments, customers may be permitted to create the metadata configuration file, but not be permitted to deploy it. Data center personnel at the ASP may deploy the metadata configuration file 117, if desired. This allows ASPs to evaluate the adaptation data 118 to look for erroneous information before applying the metadata configuration file 117 to the executable application 120.

3. A metadata configuration file 117 may be created from the configuration information 119 stored in the memory 113. Reports may be written against the created metadata configuration file 117. The reverse configuration process permits an existing metadata configuration file 117 to be compared to a proposed metadata configuration file 117 for various reasons, such as troubleshooting, updates, and changes to the existing metadata configuration file 117.

4. The configuration system 101 permits a user to conveniently apply a metadata configuration file 117 to one or more customer systems 103 at the same time or different times. After a metadata configuration file 117 is created, the metadata configuration file 117 may be reused for a subsequent deployment. Customers may select a metadata configuration file 117 from various metadata configuration files 117 to jump-start the configuration process. This provides the ability to create a number of metadata configuration files 117 (i.e., a library of models 204) that are appropriate starting points for customer systems 103 of various sizes. The adapter-based approach allows the metadata configuration file 117 to remain valid, even if the memories 113 vary among different customer systems 103.

5. The configuration system 101 permits convenient backups. The metadata configuration file 117 may be populated from the configuration information 119 stored in the memory 113 using the reverse process, and then reapplied in the case that the executable application 120 needs to be reinstalled for some reason, such as a hardware failure. The configuration system 101 also permits backing off a poor configuration by reapplying a backed up configuration.

6. The configuration system 101 permits a separation of roles between the developers of the configuration system 101 and the users of the configuration system 101. 7. The configuration system 101 permits simulation of the metadata configuration file 117. The configuration system 101 permits an administrator to simulate a user being signed onto the customer system 103 so that the administrator may have a user experience of active configuration settings, such as security. For example, a simulation may display messages floating over indications of the various configured items (e.g., tokens). For example, the message for a token, indicating what the token guards, is displayed along with a grant/deny indication for the logged on user. The simulation permits an administrator to understand how the executable application 120 will run when it is configured and deployed in the customer system 103. The simulation permits the metadata configuration file 117 to be tested and debugged, before the executable application 120 is installed, leading to faster installations and quicker realization of revenue.

8. The configuration system 101 assists with migration from a prior generation application to a next generation application. For example, the configuration system 101 helps migrate security configurations from one executable application to another. For example, the configuration system 101 may store the adaptation data 118, such as users, groups, group memberships, tokens, and permissions, in a generic form. The adapters 105 and 107 may store the specific adaptation data 118. The configuration system 101 first reads generic configuration information 119 from a prior generation executable application 120 using the reverse process to create a generic metadata configuration file 117. The configuration system 101 writes back security-related adaptation data 118 for the next generation executable application 120 using the adapters 105 and 107 to migrate a customer from the prior executable application 120 to the next executable application 120.

9. The configuration system 101 facilitates configuration change management. Metadata configuration files 117 may be saved between deployments to track the changes that have been made. In another scenario, the configuration information 119 may be read into the configuration system 101 to create a current metadata configuration file 117. The read metadata configuration file 117 may be compared against an earlier deployed metadata configuration file 117 to determine what has changed since the previous configuration was applied.

The system 100 employs the architecture 200 for collecting, managing, and deploying adaptation data 118 for one or more executable application 120 associated with one or more customer systems 103. The configuration system 101 is not tied to a particular development platform, and is capable of configuring executable applications 120 stored in the memories 113 associated with more than one development platform in a single deployment. The configuration system 101 provides a means to consolidate disparate adaptation data 118 into a single user interface. This configuration system 101 reduces the costs associated with the need to create user accounts and security groups in the Microsoft® Active Directory using the Microsoft users and computers snap-in, the setting of permissions for application features through a snap-in, and the association of user accounts to organizations within the executable application 120 using a separate security administration utility.

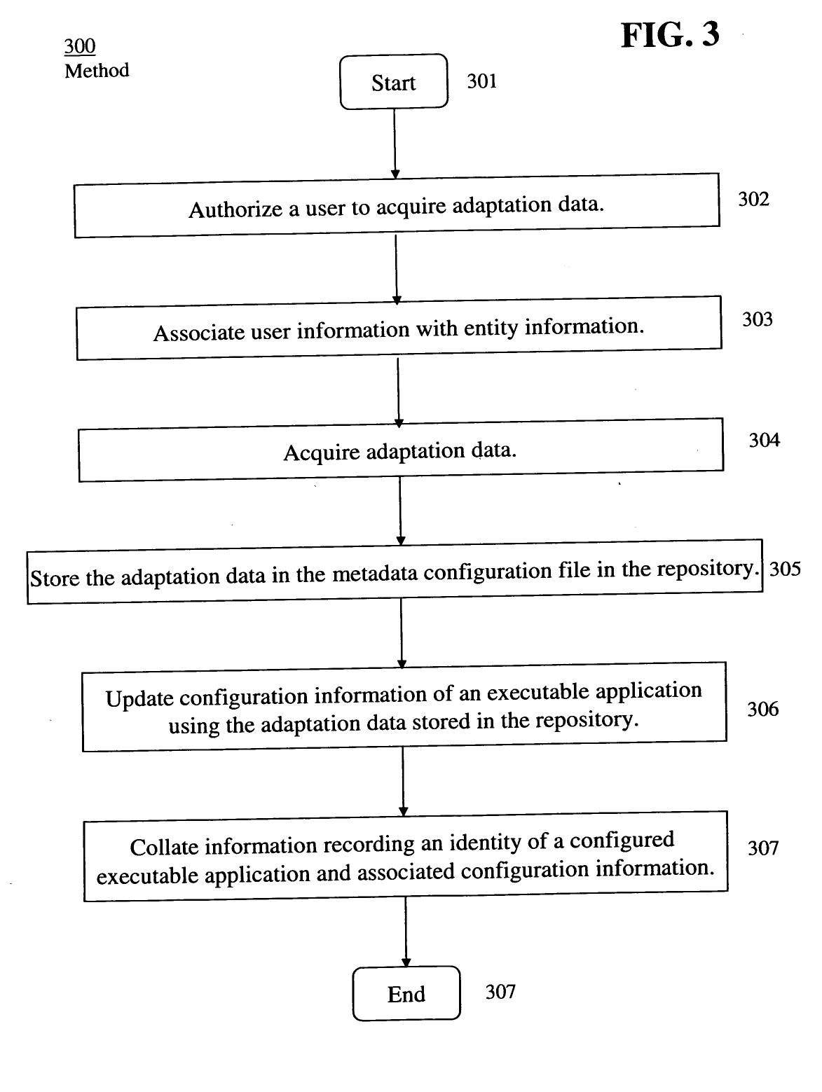

FIG. 3 illustrates a method 300 for configuring executable applications.

At step 301, the method 300 starts.

At step 302, the authorization processor 112 authorizes particular users to acquire adaptation data 118.

At step 303, the repository 106 associates user information 125 with entity information 127.

At step 304, the acquisition processor 114 acquires the adaptation data 118.

At step 305, the processor 104 stores the adaptation data 118 in the metadata configuration file 117 in the repository 106.

Steps 302, 303, 304, and/or 305 comprise a step of maintaining a repository 106 of adaptation data 118 for configuring executable applications 120, and including information determining user authorization 123 to access a particular application, and information determining a user association 125 with a predetermined entity. The repository 106 associates particular adaptation data 118 with data representing a corresponding display image on the data output device 110 used for acquiring the particular adaptation data 118 in response to user data entry.

At step 306, the deployment processor 115 updates configuration information 119 of an executable application 120 with the adaptation data 118 retrieved from the repository 106, using an executable procedure 121 associated with the adaptation data 118 in the repository 106.

At step 307, the documentation processor 116 collates information recording an identity of a configured executable application 120 and associated configuration information 119 used in configuring the configured executable application 120.

At step 308, the method 300 ends.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system for configuring an executable application, comprising:
a repository including:
adaptation data for configuring executable applications,
information determining user authorization to access a particular executable application, and
information determining user association with a predetermined entity; and
an executable procedure, being associated with the adaptation data stored in said repository, for updating configuration information associated with the particular executable application with the adaptation data retrieved from said repository.

2. A system according to claim 1, wherein
said repository associates particular adaptation data with data representing a corresponding display image used for acquiring said particular adaptation data in response to user data entry.

3. A system according to claim 1, wherein
said configuration information includes at least one of the following: (a) information associating a user with a particular group of users, (b) information indicating user authorization to access an individual executable application of a group of executable applications, (c) information indicating user authorization to access particular functions or features of an executable application, and (d) information identifying specific configuration information required by an executable application.

4. A system according to claim 1, wherein
said predetermined entity comprises at least one of the following: (a) a particular group of users, (b) an organization, (c) a department within an organization, (d) a location, and (e) a constituent part of an organization.

5. A system according to claim 1, further comprising:
an acquisition processor for acquiring adaptation data for configuring executable applications from a plurality of different sources.

6. A system according to claim 5, wherein
said plurality of different sources include at least one of the following: (a) user data entry via a displayed image used for acquiring particular adaptation data, (b) a file of adaptation data, (c) network accessed sources, and (d) a plurality of different repositories.

7. A system according to claim 1, wherein
said executable procedure is adaptively selectable for updating configuration information of a corresponding target executable application, said target executable application being associated with corresponding adaptation data in said repository.

8. A system for configuring an executable application, comprising:
a repository of adaptation data for configuring an executable application, said repository associating particular adaptation data with data representing a corresponding display image used for acquiring said particular adaptation data in response to user data entry; and
an executable procedure being associated with particular adaptation data in said repository for updating configuration information of an executable application with said particular adaptation data retrieved from said repository.

9. A system according to claim 8, wherein
said corresponding display image is adaptively selectable for acquiring particular adaptation data for configuring a corresponding target executable application.

10. A system according to claim 8, wherein
said executable procedure is adaptively selectable for updating configuration information of a corresponding target executable application, said target executable application being associated with corresponding adaptation data in said repository.

11. A system according to claim 8, including
an authorization processor for inhibiting particular users from being able to initiate execution of said executable procedure for updating said configuration information of said executable application with said particular adaptation data retrieved from said repository.

12. A system according to claim 8, including
an authorization processor for enabling particular users to be able to initiate acquisition of said particular adaptation data for storage in said repository in response to user data entry into a corresponding display image used for acquiring said particular adaptation data.

13. A system for configuring an executable application, comprising:
a repository including:
adaptation data for configuring executable applications,
information determining user authorization to access a particular application, and
information determining user association with a predetermined entity;
an executable procedure, being associated with the adaptation data stored in said repository, for updating configuration information associated with the particular executable application with said adaptation data retrieved from said repository; and
a documentation processor for collating:
information recording an identity of a configured executable application, and associated configuration information used in configuring said configured executable application.

14. A system for configuring an executable application, comprising:
a repository including:
adaptation data for configuring executable applications,
information determining user authorization to access a particular application, and
information determining user association with a predetermined entity; and
an executable procedure adaptively selectable from a plurality of executable procedures, for updating configuration information of a corresponding target executable application, said target executable application being associated with corresponding adaptation data retrieved from said repository.

15. A method for configuring an executable application, comprising the activities of:
maintaining a repository including:
adaptation data for configuring executable applications,
information determining user authorization to access a particular executable application, and
information determining user association with a predetermined entity; and
updating configuration information of an executable application with the adaptation data retrieved from said repository using an executable procedure associated with said adaptation data in said repository.

16. A method according to claim 15, further comprising the activity of:
collating information recording an identity of a configured executable application, and associated configuration information used in configuring said configured executable application.

17. A method for configuring an executable application, comprising the activities of:
maintaining a repository adaptation data for configuring an executable application, said repository associating particular adaptation data with data representing a corresponding display image used for acquiring said particular adaptation data in response to user data entry; and
updating configuration information of an executable application with said particular adaptation data retrieved from said repository using an executable procedure associated with said particular adaptation data in said repository.
